(19) United States
(12) Patent Application Publication
(10) Pub. No.: US 2021/0049557 A1
(43) Pub. Date: Feb. 18, 2021

(54) SERVING NETWORK RESOURCES BASED ON CRITERIA FOR USER RECORDS

(71) Applicant: tilr corporation, Cincinnati, OH (US)

(72) Inventors: Luke Vigeant, Ontario (CA); Carisa Miklusak, Ossining, NY (US); Summer Crenshaw, Cincinnati, OH (US)

(21) Appl. No.: 16/822,509

(22) Filed: Mar. 18, 2020

Related U.S. Application Data
(63) Continuation of application No. 15/491,659, filed on Apr. 19, 2017, now abandoned.
(60) Provisional application No. 62/324,833, filed on Apr. 19, 2016.

(51) Int. Cl. G06Q 10/10

(52) U.S. Cl. CPC G06Q 10/1053; G06Q 50/2057

(57) ABSTRACT

A method includes receiving a request associated with a first attribute and a criterion, the request representative of an opportunity for employment, each first attribute representative of a qualification associated with the opportunity for employment, the criterion representative of a target affiliation; querying a database to identify a record including a second attribute satisfying the first attribute associated with the request and including a third attribute satisfying the criterion associated with the request, the first attribute included in the record having been determined based on other information in the record; and serving, to a computing device operated by a user associated with the identified record, a network resource providing the user with access to information about the request.

### CLAIMS OF PRIORITY

This application is a continuation of U.S. patent application Ser. No. 15/491,659, filed on Apr. 19, 2017, which claims priority to U.S. Patent Application Ser. No. 62/324,833, filed on Apr. 19, 2016, the entire contents of which are incorporated here by reference.

### BACKGROUND

A user of a computing device can request a network resource to obtain information about an opportunity, such as an employment opportunity, for which he or she believes they are qualified. The network resource can be served to the computing device to provide the user with information and to enable to user to take actions to pursue the opportunity.

### SUMMARY

In an aspect, a method includes receiving a request associated with a first attribute and a criterion, the request representative of an opportunity for employment, each first attribute representative of a qualification associated with the opportunity for employment, the criterion representative of a target affiliation; querying a database to identify a record including a second attribute satisfying the first attribute associated with the request and including a third attribute satisfying the criterion associated with the request, the first attribute included in the record having been determined based on other information in the record; and serving, to a computing device operated by a user associated with the identified record, a network resource providing the user with access to information about the request.

Embodiments can include one or more of the following features.

The method includes updating a table to include a representation of the identified record.

The method includes updating a data storage to include an identifier of the identified record.

The method includes updating a data storage to include a reference to the identified record.

The criterion is representative of an employer.

The criterion is representative of a coalition of employers.

The criterion is representative of a first target affiliation and a second target affiliation, and in which querying the database includes querying the database to identify a record for which the third attribute matching the first target affiliation; and if no record including a third attribute matching the first target affiliation is identified, querying the database to identify a record for which the third attribute matches the second target affiliation.

The method includes querying the database to identify a second record associated with a second request representative of a second opportunity for employment, the second record including a third attribute satisfying the criterion, the second record not including an attribute satisfying the first attribute; and serving, to the computing device, a network resource providing the user with access to information about the second request.

The method includes identifying a training opportunity associated with an attribute satisfying the first attribute; and serving, to the computing device, a network resource providing the user with access to information about the training opportunity.

In an aspect, a non-transitory computer readable medium stores instructions for causing a computing system to receive a request associated with a first attribute and a criterion, the request representative of an opportunity for employment, each first attribute representative of a qualification associated with the opportunity for employment, the criterion representative of a target affiliation; query a database to identify a record including a second attribute satisfying the first attribute associated with the request and including a third attribute satisfying the criterion associated with the request, the first attribute included in the record having been determined based on other information in the record; and serve, to a computing device operated by a user associated with the identified record, a network resource providing the user with access to information about the request.

Embodiments can include one or more of the following features.

The instructions cause the computing system to update a table to include a representation of the identified record.

The instructions cause the computing system to update a data storage to include an identifier of the identified record.

The instructions cause the computing system to update a data storage to include a reference to the identified record.

The criterion is representative of a first target affiliation and a second target affiliation, and in which querying the database includes querying the database to identify a record for which the third attribute matching the first target affiliation; and if no record including a third attribute matching the first target affiliation is identified, querying the database to identify a record for which the third attribute matches the second target affiliation.

The instructions cause the computing system to query the database to identify a second record associated with a second request representative of a second opportunity for employment, the second record including a third attribute satisfying the criterion, the second record not including an attribute satisfying the first attribute; and serve, to the computing device, a network resource providing the user with access to information about the second request.

The instructions cause the computing system to identify a training opportunity associated with an attribute satisfying the first attribute; and serve, to the computing device, a network resource providing the user with access to information about the training opportunity.

In an aspect, a method includes receiving, from a computing device associated with a first user, a request to access a second user record of a second user, the second user record including a group attribute and a qualification attribute; determining that a first user record of the first user includes a role attribute sufficient to permit access to the second user record, and determining that the group attribute of the first user record satisfies a group attribute of the second user record; based on the determining, serving, to the computing device associated with the first user, a network resource providing the first user with access to the second user record; querying a database to identify an opportunity record including a qualification attribute, the qualification attribute of the second user record satisfying the qualification attribute of the opportunity record; and serving, to the computing device associated with the first user, a network resource providing the first user with access to the opportunity record.

Embodiments can include one or more of the following features.

The method includes querying the database to identify a second opportunity record including a qualification attribute, the qualification attribute of the second user record not satisfying the qualification attribute of the opportunity record.

The method includes serving, to the computing device associated with the first user, a network resource providing the first user with access to the second opportunity record.

The method includes serving, to the computing device associated with the first user, a network resource providing the first user with access to information about a training opportunity associated with an attribute satisfying the qualification attribute of the second opportunity record.

### BRIEF DESCRIPTION OF DRAWINGS

FIG. 1 is a system diagram.

FIG. 2 is a system diagram.

FIG. 3 is a diagram of a database.

FIG. 4 is a flow chart.

FIGS. 5A, 5B, and 6-10 are screenshots.

### DETAILED DESCRIPTION

We describe here an approach to providing network resources, e.g., web pages, pages of a mobile application, etc., to a user based on attributes associated with the user. A system receives a request associated with one or more attributes and one or more criteria. Responsive to the request, the system queries a database storing user records, each user record associated with a corresponding user, to identify a user record having attributes that match the attributes associated with the received request and satisfying the criteria associated with the received request. The system provides network resources to a user associated with the identified user record, the network resources providing the user with access to information about the request. For example, the network resources provided to the user can provide the user with access to information about the request.

In some examples, the request can be a request for a user possessing one or more qualification attributes associated with an available opportunity for employment, such as skill, tool, or certification attributes. In some examples, the request can be a request for a user satisfying one or more criteria associated with the available opportunity, such as a criterion indicative of an employment affiliation of the user, a criterion indicative of a work schedule of the user, or other criteria. The database storing user records can be queried to identify a user record associated with a user possessing the one or more qualification attributes indicated by the request and satisfying the associated criteria. Network resources provided to the user associated with the identified user record can provide the user with access to information about the opportunity.

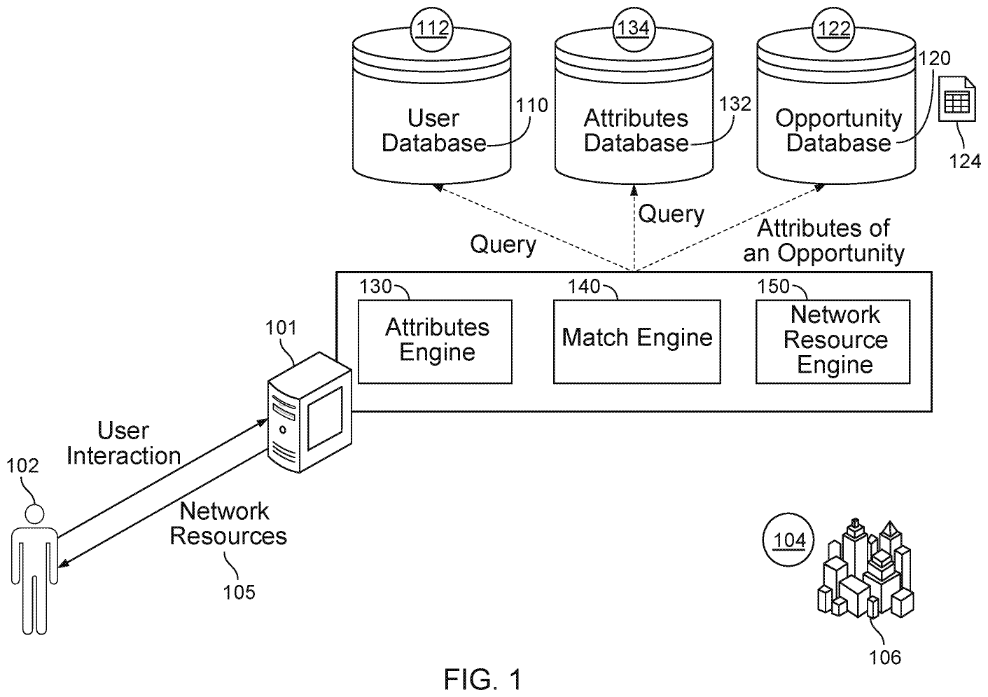

Referring to FIG. 1, a system 100 implemented by a server 101 enables a user 102 of the system 100 to be provided with network resources 105 associated with an opportunity 104 offered by an employer 106. An opportunity 104, for example, is an opportunity for employment with the employer 106. Each opportunity 104 represents an employment position (e.g., Barista, Administrative Assistant, Warehouse Clerk, or another position) having a specified schedule. An opportunity 104 can be a one-time occurrence (e.g., a Mail Clerk for Apr. 12, 2016, from 9 am-5 pm), a short-term recurring position (e.g., a Bartender from 6 pm-2 am from Apr. 1, 2016 to Apr. 8, 2016), a long-term recurring position (e.g., a Lifeguard from 10 am-6 pm from Jun. 1, 2016 to Sep. 1, 2016), or a permanent position (e.g., a Legal Secretary from 8 am-5 pm, Monday through Friday, beginning on May 2, 2016).

In some examples, an opportunity offered by a particular employer can be for a user already employed by that employer, in which case the system acts as a staffing coordinator, placing employees into shifts according to employer's scheduling needs and employee's abilities and scheduling availability. In some cases, an opportunity is restricted only to employees. In some cases, the opportunity can give first preference to employees and second preference to other users of the system, e.g., to find temporary workers if no employee is available or qualified. In some cases, the employer is part of a coalition of employers who share labor resources, and an opportunity by an employer may give first preference to its own employees, and second preference to employees of other employers in the coalition if none of its own employees are available and/or qualified. The opportunity can be restricted to only employees and coalition employees or can also be offered to non-employee users of the system, e.g., to find temporary workers if no employee or coalition employee is available and/or qualified.

In some examples, an opportunity offered by an employer can be offered only to a user of the system who is already an employee of the employer or otherwise employed by the employer, such as a contractor to the employer. For instance, the system can act as a scheduling coordinator to assign shifts to employees of a coffee shop based on the scheduling needs of the coffee shop (e.g., as represented by opportunities offered by the coffee shop through the system) and based on the availability of the employees.

In some examples, an opportunity offered by an employer can be offered to either a user of the system who is already an employee of the employer or otherwise employed by the employer or to a user of the system who is not an employee of the employer. The user to whom an opportunity is offered can be determined based on one or more rules defined by the employer. For instance, an employer may indicate that an opportunity is to be offered to a non-employee only if no qualified employee is available for the opportunity.

In some examples, an employer may belong to a coalition of employers, such as employers in a similar field and geographical location. For instance, several independent coffee shops in Brooklyn may form a coalition. An opportunity offered by one of the coffee shops in the coalition can be offered to either an employee of that coffee shop or to an employee of another one of the coffee shops in the coalition (sometimes referred to as coalition employees). The user to whom an opportunity is offered can be determined based on one or more rules defined by the employer offering the opportunity or defined by the coalition. For instance, a coalition of employers may indicate that an opportunity offered by a particular one of the employers is to be offered first to a qualified employee of the particular employer, and if no such employee is available, to a qualified coalition employee who has worked or is scheduled to work less than 20 hours during the week of the opportunity. The ability to offer opportunities to coalition employees can help employers in the coalition to find qualified workers who have direct experience in environments that the employers regard as similar, e.g., if their own workers are unavailable or would otherwise be scheduled for overtime.

Each user 102 of the system 100 possesses a set of qualification attributes, such as skill, tool, and/or certification attributes the user has accumulated through education or previous or current employment experience. Each opportunity 104 offered through the system 100 is associated with a set of qualification attributes, such as skill, tool, and/or certification attributes the employer 106 offering the opportunity expects that a person qualified for the opportunity will possess. The system 100 can automatically identify one or more users 102 that are qualified for a particular opportunity 104 based on a match between the qualification attributes (e.g., skill, certification, and/or tools attributes) possessed by each user 102 and the qualification attributes associated with the particular opportunity 104.

The server 101 can serve network resources 105 associated with the particular opportunity 104 to one or more of the users 102 identified as qualified for the opportunity. Through an interaction with the network resources 105, the user 102 can accept the opportunity 104 and complete pre-employment tasks for the opportunity, such as providing information for a background check, providing bank account routing information or tax information, or other tasks. The ability to accept the opportunity and complete related pre-employment tasks without human intervention, such as without intervention by a human resources professional, enables the user to be efficiently assigned to the opportunity and frees human resources professionals at the employer to focus on other tasks.

The server 101 can access a user database 110 that stores a user record 112 for each user 102. The user record 112 for a user 102 can be established upon enrollment of the user 102 with the system 100. The user record 112 for a user 102 can include an identifier of the user's employer, an identifier of a coalition to which the user's employer belongs, or both.

The user record 112 for a particular user 102 can include biographical information about the user 102 (e.g., the user's name, address, e-mail address, phone number, or other biographical information), information about the user's work history, information about the user's educational history, skills possessed by the user, a level of proficiency for each skill, certifications possessed by the user, tools at which the user is proficient, a level of proficiency for each tool, or other information. Information about the user's work history can include titles of jobs previously or currently held by the user, names of previous or current employers, or other information. Information about the user's educational history can include degrees earned by the user, degrees partially completed by the user, coursework completed or in progress, professional certifications, or other information.

In some examples, the user record 112 for a user 102 can include attributes indicative of user preferences, such as location attributes (e.g., indicative of a geographical area the user prefers for his opportunities, a geographical area outside of which the user will not consider opportunities, or other location preferences), schedule attributes (e.g., indicative of preferred days or times for opportunities, days or times the user is unavailable for opportunities, or other schedule preferences), or other attributes. In some examples, the user record 112 can include information about opportunities previously completed by the user, such as the user's rating of a previous opportunity or an employer's rating of a user following completion of a previous opportunity (discussed below).

Some information stored in the user record 112 for a particular user 102 can be entered by the user. For instance, the user 102 can enter biographical information, work history or educational history information, user preferences, or other information. Some information stored in the user record 112 can be determined by the system 100, in conjunction with input from the user. For instance, an attributes engine 130 can identify the qualification attributes (e.g., skill, certification, and/or tool attributes) possessed by the user and/or a level of proficiency associated with each qualification attribute (e.g., the level of proficiency for each skill or tool or the level of a multi-level certification achieved by the user) based on information about the user, such as based on the user's work history or educational history.

Additional description of the attributes engine can be found in co-pending U.S. application Ser. No. [TBA—Attorney Docket No. 43032-0002001], the contents of which are incorporated here by reference in their entirety. In some examples, a user can acquire attributes through activities undertaken through the system 100, such as through completion of opportunities or education offered through the system 100. The attributes engine 130 can automatically update a user's user record 112 to reflect the attributes acquired through the system.

An attributes engine 130 implemented by the server 101 can identify one or more qualification attributes that may be possessed by a particular user 102 based on information about the user. For instance, a user may provide information about a previous job, including the title of the position. An attributes database 132 includes job title records 134, each of which includes a job title and an indication of any related job titles (e.g., a pointer to a job title record of each related job title). The attributes engine 130 queries the attributes database 132 to identify one or more job title records 134 that include job titles that are similar or related to the title entered by the user. Each job title record 134 also includes a list of qualification attributes associated with the job title or a reference (e.g., a pointer) to each qualification attributes associated with the job title. The attributes engine 130 identifies a list of the qualification attributes associated with each of the identified job title records 134. The identified qualification attributes are presented to the user via a network resource rendered as a web page (e.g., based on HTML code), a page of a mobile application, or another rendering of the network resource. The user can interact with the network resource to indicate which of the presented qualification attributes (e.g., skills, certifications, or tools) he possesses, and in some cases a level of proficiency associated with each qualification attribute. Based on the user interaction with the network resource, qualification attributes (and, in some cases, a of proficiency associated with each qualification attribute) are stored in the user record 112.

The qualification attributes can be skill attributes indicative of skills possessed by the user. Skills are capabilities that the user has acquired through past employment, education, and/or other experiences. The qualification attributes can be certification attributes indicative of certifications possessed by the user. A certification is achieved by a user who completes a defined set of activities to achieve the certification, such as classes, trainings, or exams. Certifications can be issued by governmental bodies, trade or professional organizations, employers, or other entities. The qualification attributes can be tool attributes indicative of tools with which the user is proficient. Tools can be physical tools, such as a forklift, an arc welder, or an espresso machine; or software tools, such as word processing or billing software or programming languages.

In an example, if a user enters the title “Admin Assistant,” the attributes engine 130 may query the attributes database 132 to identify the following similar or related job titles: Administrative Assistant, Executive Assistant, Secretary, Office Manager. A list of the qualification attributes associated with one or more of the job titles Administrative Assistant, Executive Assistant, Secretary and Office Manager is presented to the user. The user can then select the skills and certifications he possesses and the tools at which he is proficient from the presented list of qualification attributes, and in some cases can indicate his level of proficiency for each selected skill, certification, and/or tool. The selected skills, certifications, and/or tools are stored as qualification attributes in the user record 112.

The system 100 includes an opportunity database 120 that stores an opportunity record 122 for each available opportunity 104 in the system 100. The opportunity record 122 for a particular opportunity 104 can include the title of the position represented by the opportunity, information about the employer 106 offering the opportunity (e.g., the name of the employer, contact information for the employer, or other information), qualification attributes (e.g., skill, certification, and/or tool attributes) associated with the opportunity, a level of proficiency associated with each qualification attribute, a location attribute for the opportunity, a schedule attribute for the opportunity, a description of the opportunity (e.g., including text, images, video, or other types of data), or other information.

The opportunity record 122 for an available opportunity 104 can include an affiliation attribute for a user to be assigned to the opportunity. For instance, the affiliation attribute can indicate whether an opportunity offered by an employer is to be assigned only to a user who is an employee of the employer, to a user who is a coalition employee, or to a non-employee user.

The opportunity record 122 for an available opportunity 104 can include rules to be applied when identifying users for the opportunity. The rules can represent business goals or rules established by the employer, such as a minimization of employees scheduled for overtime, a desire to keep employees scheduled at consistent times and on consistently staffed teams where possible, an approach to staffing openings resulting from unplanned absences, or other business goals or rules. An example rule can indicate that an opportunity offered by an employer is to be offered first to a user who is an employee of the employer, and then to a user who is a coalition employee, and then to a non-employee user. An example rule can indicate that a user may not be assigned an opportunity if doing so would cause the user to be scheduled for overtime, such as for more than 8 hours of work in the day of the opportunity or more than 40 hours of work in the week of the opportunity. An example rule can indicate that, during an unplanned absence (e.g., when an employer denotes within the system that an employee is an absent), employees, such as qualified employees of the employer or qualified coalition employees, can be notified that an opportunity is available. The party that accepts the notification first can receive the shift.

Some information stored in the opportunity record 112 for a particular opportunity 104 offered by an employer 106 can be entered by or on behalf of the employer, such as the title of the position, information about the employer, a location of the opportunity, a schedule for the opportunity, a description of the opportunity, or other information. Some information stored in the opportunity record 112 can be determined by the system 100, in conjunction with input from or on behalf of the employer. For instance, the attributes engine 130 can identify qualification attributes to be associated with the opportunity 104 and/or a level of proficiency associated with each qualification attribute based on information about the opportunity, such as based on the title of the position, as described above.

A match engine 140 identifies one or more users (e.g., the user 102) as qualified for a particular opportunity 104 based on a comparison between the qualification attributes possessed by the users 102 and the qualification attributes associated with the opportunity 104, according to any rules indicated in the opportunity record 122. For instance, to identify users for a particular opportunity 104, the match engine 140 can query the user database 110 to identify those user records having all of the qualification attributes included in the opportunity record 122 for the particular opportunity 104 and having the affiliation attribute indicated in the opportunity record 122. In some examples, the opportunity record 122 for the particular opportunity includes a level of proficiency associated with one or more of the qualification attributes, and the match engine 140 can query the user database 110 to identify those user records (e.g., record 112) having all of the qualification attributes included in the opportunity record 122 and having the indicated level of proficiency for each of one or more of the qualification attributes. We sometimes refer to user records (e.g., record 112) that have all of the qualification attributes included in the opportunity record 122 for a particular opportunity, having the indicated level of proficiency for each of one or more of the qualification attributes, and satisfying any rules indicated in the opportunity record 122 as user records that are matched with the opportunity record.

In some examples, the opportunity record 122 can include rules that indicate a weighting factor for one or more of the qualification attributes included in the opportunity record and/or for the affiliation attribute included in the opportunity record. The match engine 140 can apply each weighting factor indicated in the opportunity record to the respective qualification attribute and/or affiliation attribute in each user record in order to identify user records that are matched with the opportunity record. The weighting factors can enable users that possess particular qualification attributes to be identified, can help implement an employer's preference for staffing internal employees over temporary workers, or other goals. The use of a weighting factor can enable an employer to implement preference and to access skills, certifications, and/or tool proficiencies that may be available in a large labor pool even if those skills are unavailable in the employer's own labor pool.

For instance, each of one or more qualification attributes associated with an opportunity is assigned a weighting factor to indicate its relative importance as compared with other qualification attributes associated with the opportunity. A user record (e.g., record 112) can be identified as a match for an opportunity 104 subject to the qualification attributes and associated weighting factors for the opportunity. In an example of a rule, if a user record is missing a highly weighted qualification attribute associated with an opportunity, the user record may not be identified as a match, but a user record missing a lower weighted qualification attribute may still be identified as a match. In an example of a rule, a score can be determined for a record based on the qualification attributes and associated weighting factors, and the record can be identified as a match if the score exceeds a threshold score. In an example of a rule, a score can be determined for each of multiple records based on the qualification attributes and associated weighting factors, and the record having the highest score can be identified as a match.

In a specific example, a restaurant offers an opportunity for a sushi chef. Rules associated with the opportunity can indicate that internal employees are preferred, that only internal employees or coalition employees are permitted, and that the skill attribute “Sushi preparation” is to be highly weighted. Under these rules, if no internal employee of the restaurant possesses the skill attribute “Sushi preparation,” the opportunity will be offered to a coalition employee possessing this skill attribute.

In some examples, user records (e.g., record 112) identified as matched with an opportunity record are stored in a match table 124 associated with the opportunity record. In some examples, user records 112 identified as matched with an opportunity record can be tracked in another way, such as through a document storing identifiers of the user records or references (e.g., pointers) to the user records.

In some examples, the match engine 140 can identify one or more users for a particular opportunity 104 based on information other than qualification and affiliation attributes. For instance, the match engine 140 can query the user database 110 to identify those user records (e.g., record 112) having location or schedule attributes that are consistent with the location or schedule for the opportunity.

A network resource engine 150 renders a network resource, such as a web page or a page of a mobile application, for presentation to one or more of the users 102 whose user record (e.g., record 112) was identified by the match engine 140. The network resource can include information about the opportunity 104. Through the network resource, the one or more users 102 are prompted to respond to accept or decline the opportunity 104. When an acceptance is received from a user 102, the user record 112 for the user 102 is updated to reflect that the user 102 is assigned to the opportunity 104. If a user declines the opportunity, the opportunity can be presented to another user.

Additional description of approaches to offering the opportunity to the user and enabling the user to accept and complete the opportunity can be found in co-pending U.S. application Serial No. Ser. No. 15/491,475, filed on Apr. 19, 2017, the contents of which are incorporated here by reference in their entirety.

The approach of the system 100, in which users are identified as qualified for a particular opportunity based on matching of qualification attributes between the user's user record 112 and the opportunity record 122 for the opportunity, enables qualified users to be offered opportunities even if the opportunity differs from previous jobs the user has held. For instance, a qualified user may be offered an opportunity for a Wait Staff position even if the user has not previously worked as a waiter. Offering opportunities to qualified users enables efficient use of the labor pool of users in the system and helps to provide employment to users and to fill open positions with employers.

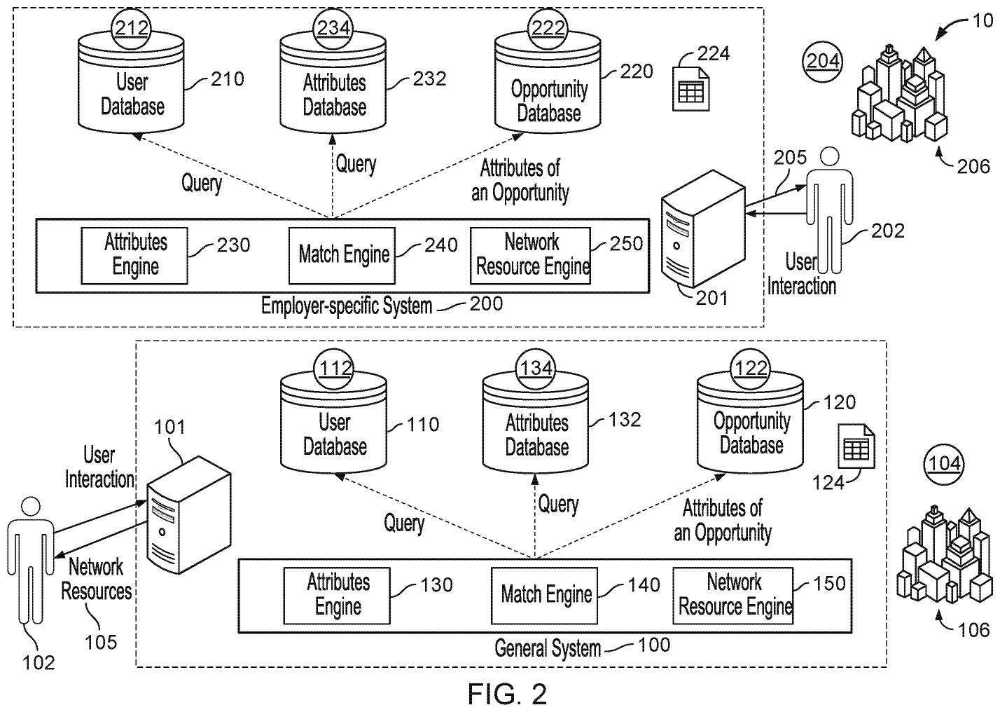

Referring to FIG. 2, a system 10 can support both the system 100, described above, and an employer-specific system 200. The employer-specific system 200 is operated by or on behalf of a particular employer 206, and the role of the employer-specific system is to act as an internal staffing system that enables opportunities 204 offered by the employer 206 to be offered to employees 202 of the employer 206. In some examples, the employer-specific system 200 can be implemented as part of an internal communications network (e.g., an intranet) 205 of the employer 206. The opportunities 204 offered through the employer-specific system 200 are inaccessible to users 102 of the system 100, and conversely the employees 202 of the employer 206 cannot be offered opportunities 104 through the system 100.

Through the employer-specific system 200, an employee 202 (e.g., a permanent or temporary employee, a contractor, or another affiliation) of the employer 206 can be provided with network resources 205 associated with an opportunity 204 associated with the employer 206. Through an interaction with the network resources 205, e.g., provided via an internal communications network of the employer 206, the user 202 can accept the opportunity 204.

The operation of the employer-specific system 200 is generally similar to that of the system 100, described above. The employer-specific system 200 is implemented by a server 201 that is operated by or on behalf of the employer 206. The server 201 can access a user database 210 that stores a user record 212 for each employee 202. The user database 210 can be separate from the user database 110 that forms part of the system 100. The user records 202 can include information such as the information included in the user records 112, described above. For instance, the user record 212 for an employee 202 can include biographical information about the employee, work history or educational history information, employee preferences such as location preferences or schedule preferences, or other information. The employee record 212 can include qualification attributes (e.g., skill, certification, and/or tool attributes) possessed by the employee and/or a level of proficiency associated with each qualification attribute.

In some examples, the qualification attributes and/or level of proficiency for each qualification attribute can be determined by an attributes engine 230 that queries an attributes database 232 that is specific to the system 250 in order to identify potential attributes possessed by an employee. For instance, the attributes database 232 can include job title records 234, each of which includes a job title for a position with the employer 206 and a list of one or more qualification attributes associated with the job title. An attributes database 232 that is specific to the system 250 can enable the employer 206 to define job titles and associated qualification attributes that reflect the qualification attributes that a person is likely to have acquired when working in a position with a particular job title at the employer 206. For instance, the employer 206 can create a job title record 234 for an uncommon job title (e.g., “Cocktail Experience Manager”) that would otherwise be unavailable in the general attributes database 132 of the system 100.

In some examples, the attributes engine 230 can query the attributes database 132 that is part of the system 100. By querying the attributes database 132, the attributes engine 230 can gain access to job title records 134 for common job titles or for job title records 134 that have been accumulated based on the system 100's analysis of large numbers of user records 112 from the general public. In some examples, the attributes engine 230 queries both the attributes database 132 and the attributes database 232.

The employer-specific system 200 includes an opportunity database 220 that stores an opportunity record 222 for each available opportunity 204 offered by the employer 206. The opportunity records 222 can include information such as the information included in the opportunity records 122, described above. For instance, the opportunity record 222 for an opportunity 204 can include the title of the position represented by the opportunity, qualification attributes (e.g., skill, certification, and/or tool attributes) associated with the opportunity, a level of proficiency associated with each qualification attribute, a location attribute for the opportunity, a schedule attribute for the opportunity, a description of the opportunity, or other information. In some examples, the qualification attribute and/or level of proficiency for each qualification attribute can be determined by the attributes engine, e.g., by querying one or more of the attributes database 132 and the attributes database 232.

A match engine 240 identifies one or more employees (e.g., the employee 202) as qualified for a particular opportunity 204 based on a match between the qualification attributes possessed by the users and the qualification attributes associated with the opportunity 204. The match engine 240 can also identify users based on other information, for instance, by identifying user records having location or schedule attributes that are consistent with the location or schedule attributes for the opportunity. The match engine 240 can apply any rules indicated in the opportunity record 222 for the opportunity in order to identify qualified employees that satisfy the employer's business goals or objectives.

A network resource engine 250 renders a network resource, such as a web page or a page of a mobile application, for presentation to one or more of the employees 202 whose employee record (e.g., record 212) was identified by the match engine 240. The network resource can include information about the opportunity 204. Through the network resource, the one or more employees 202 are prompted to respond to accept or decline the opportunity 204. When an acceptance is received from an employee 204, the employee record 212 for the employee 204 is updated to reflect that the employee 204 is assigned to the opportunity 204. If an employee declines the opportunity, the opportunity can be presented to another employee.

The employer-specific system 200 enables the employer 206 to utilize his labor resources efficiently, for instance, by scheduling qualified employees for shifts in which the employees are available while minimizing the amount of overtime work undertaken by the labor force. The scheduling and staffing capabilities of the employer-specific system 200 can provide a manager with free time to devote to other tasks.

In some examples, the employer-specific system 200 can be utilized as a career development system for employees. For instance, an employee can view ratings received from managers or supervisors, e.g., to help the employee understand his strengths and weaknesses. The employee can access a list of internal positions for which he is qualified, e.g., based on a match between the qualification attributes in the employee's user record and the qualification attributes of the internal positions. The employee can access a list of internal positions for which he is almost qualified, e.g., positions for which the employee lacks one or more qualification attributes. The employee can access information about projects and/or trainings that can help the employee to gain qualifications that would help him become qualified for one or more additional internal positions.

In some examples, the employer-specific system 200 can be utilized as an employee management system, e.g., to allow a supervisor can view user records for the employees she supervises. For instance, the user record for each employee can include a group attribute indicative of an internal group to which the employee belongs, such as a corporate division, a practice group, a group of employees sharing the same manager, or another type of group. A supervisor for a group can access the user records for all of the employees in the group. For instance, the user record for a supervisor can include a group attribute indicative of the internal group to which the supervisor belongs and a role attribute indicative of the user's role as supervisor. The presence and/or value of the role attribute enables the supervisor to view and/or edit the user records sharing the same value for the group attribute.

In some examples, the supervisor can view ratings received by the employees, e.g., enabling the supervisor to monitor employee performance. The supervisor can access a list of internal positions for which an employee is qualified, e.g., enabling the supervisor to encourage the employee to take on a new project or work with a new internal group. The supervisor can access a list of internal positions for which an employee is almost qualified, e.g., for which the employee lacks one or more qualification attributes. Access to this information can enable the supervisor to encourage the employee's career development, e.g., to prompt the employee to take on projects or attend trainings that would help the employee gain qualifications that would help with her career progression.

In some examples, the employer-specific system 200 can be utilized to facilitate internal staffing, e.g., for internal opportunities or projects. Using a search interface of the employer-specific system 200, a hiring manager, project manager, or other user can search for internal employees having specific qualifications, such as skills, certifications, or tool proficiencies. When a search is initiated for a particular set of qualifications, an opportunity record having the desired qualification attributes is created. Internal user records having qualification attributes that match the qualification attributes of the opportunity record are identified, e.g., as described above. This internal search capability allows internal expertise to be effectively leveraged, e.g., by making employee's skill sets accessible to managers throughout the company.

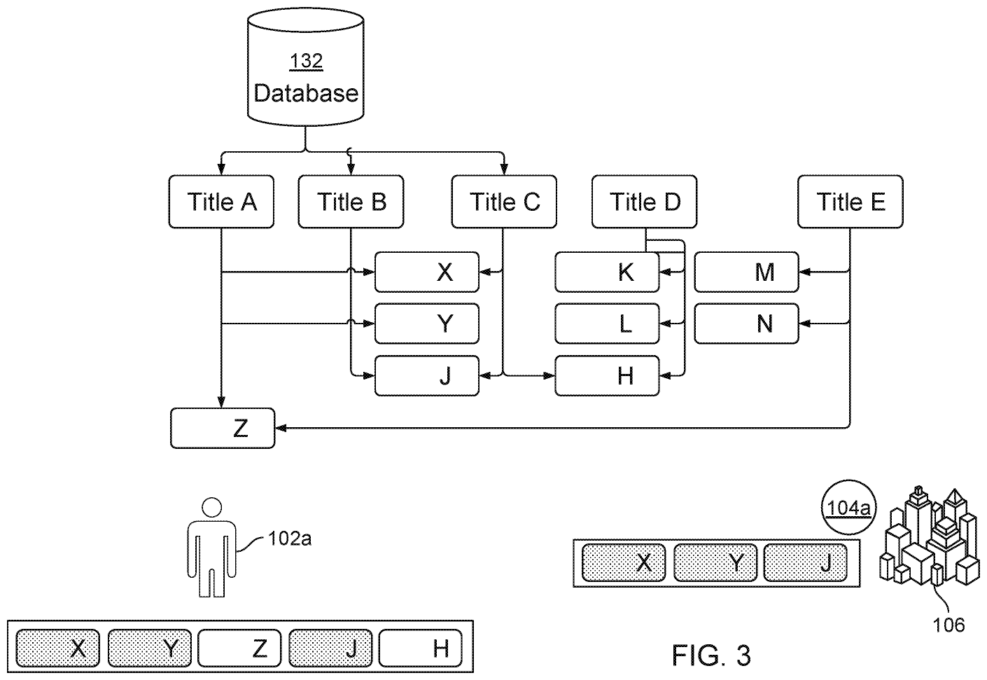

Referring to FIG. 3, in a specific example, the attributes database 132 includes job title records 134 for five job titles: Title A, Title B, Title C, Title D, and Title E. The example of FIG. 3 can similarly depict the attributes database 232 including job title records 234. Each job title record 134 includes references to the associated with the job title of the record. For instance, the job Title A is associated with the qualification attributes X, Y, and Z. The job Title B is associated with the qualification attributes X, Y, and J. The job Title C is associated with the qualification attributes X, J, and H. In a specific example, Titles A, B, and C may be Custodian, Housecleaner, and Gardener, respectively. The qualification attribute X may be “Manual labor,” the qualification attribute Y may be “Cleaning,” the qualification attribute Z may be “Facilities management,” the qualification attribute J may be “Managing client expectations,” and the qualification attribute H may be “Working outdoors.”

In this example, a user 102a has worked in a Title A role (e.g., Custodian) and a Title C role (e.g., Gardener) and has indicated (e.g., during an enrollment process) that he has acquired all of the qualification attributes associated with these two roles. The worker 102a thus possesses the qualification attributes X (Manual labor), Y (Cleaning), Z (Facilities management), J (Managing client expectations), and H (Working outdoors). Although the user has never worked in a Title B role (e.g., Housecleaner), the match engine 140 identifies the user 102a as qualified for an opportunity 104a in a Title B role because the user 102a possesses all of the qualification attributes associated with the Title B role.

In the example of FIG. 3, the user 102a is identified as qualified for the opportunity 104a based on a comparison between the qualification attributes possessed by the user 102a and the qualification attributes associated with the opportunity 104a. In some examples, other criteria can be used in addition to matching of skills to determine whether the user 102a is to be offered the opportunity 104a. For instance, the user's location or schedule attributes or the user's previous experiences in opportunities offered through the system can be taken into account, e.g., as described above.

In some examples, although the user 102a is qualified for the opportunity 104a, the user 102a may still be subject to affiliation rules or other rules associated with the opportunity. In an example, if the user 102a is a coalition employee but not an employee of the employer offering the opportunity 104a. If the opportunity is to be offered first to employees of the employer who possess two out of the three qualification attributes associated with the opportunity, then the user 102a may not be offered the opportunity despite being qualified for the opportunity. In an example, if the user 102a has already been scheduled to work 40 hours in the week of the opportunity, then the user 102a may not be offered the opportunity even if the user is the most qualified for the opportunity.

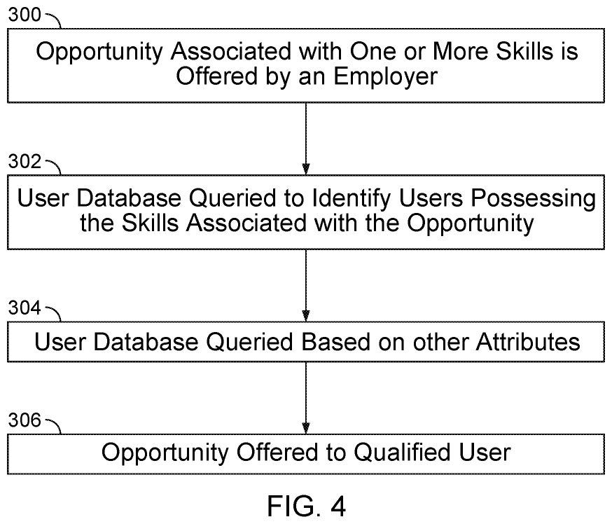

Referring to FIG. 4, in an example process, an opportunity associated with one or more skills is offered for a position with an employer (300). The opportunity can also be associated with one or more rules, such as rules indicative of an affiliation, rules indicative of scheduling management (e.g., overtime management), or other rules. For instance, in the example of FIG. 2, the opportunity for a Title B position offered by an employer is associated with the qualification attributes X, Y, and J and is associated with an affiliation attribute indicating that the opportunity can be offered only to employees of the employer. A query is undertaken to identify users in the system who satisfy the rules associated with the opportunity (e.g., users who are employees of the employer) and who possess the qualification attributes associated with the opportunity (302). For instance, the user database is queried to identify user records that include qualification attributes matching those associated with the opportunity. The user database can also be queried on other attributes (304), such as location or schedule attributes, to identify user records that are suited for the opportunity. The opportunity is offered to one or more of the users whose user record is identified by the query or queries (306).

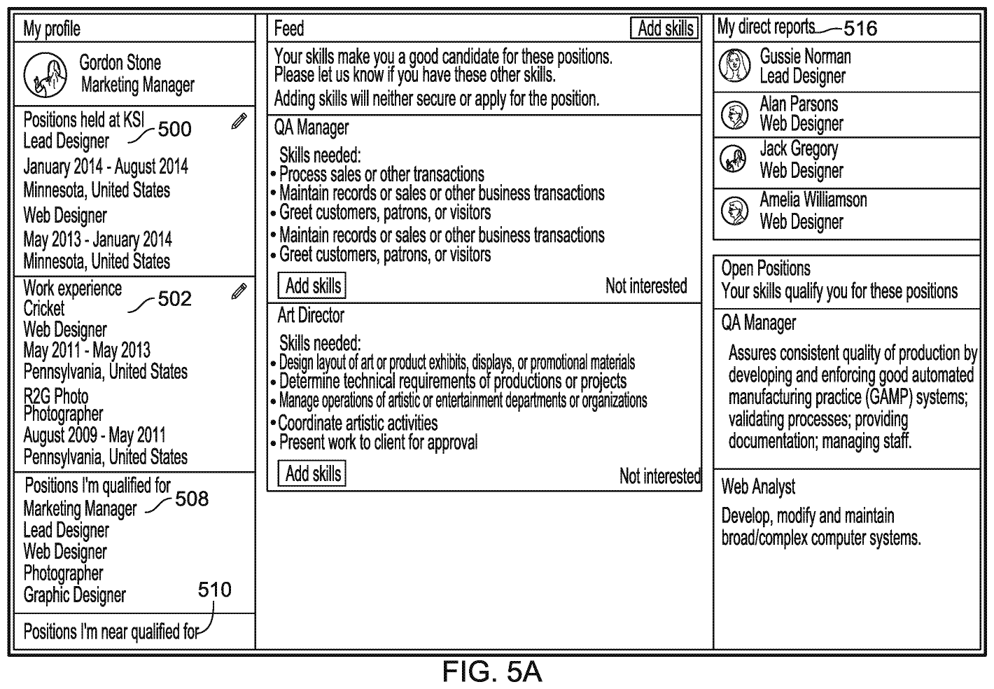

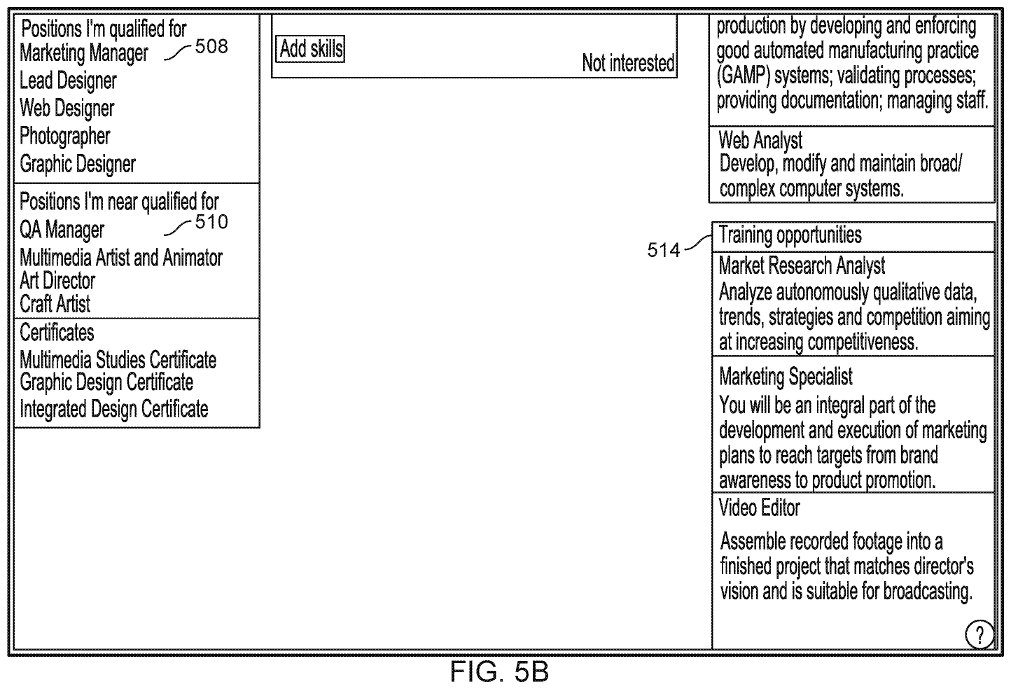

FIGS. 5A, 5B, and 6-8 are screenshots of an internal resource management system implemented for employee career development.

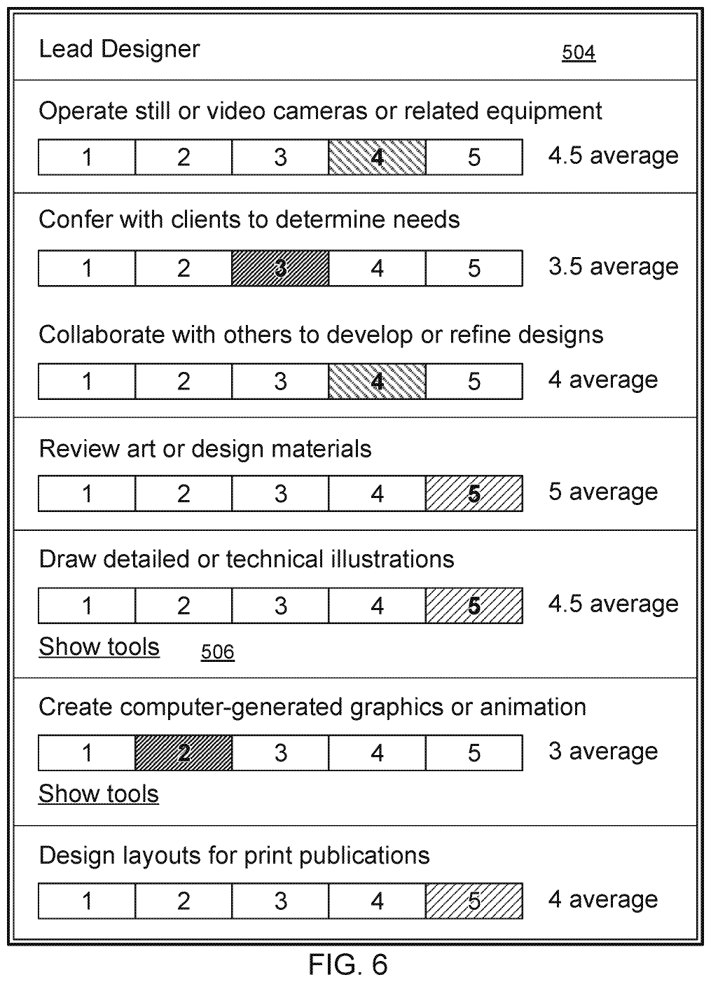

Referring to FIG. 5A, a user can view a list 500 of internal positions and a list 502 of external positions held. Through these positions, the user may have accumulated qualifications. Referring also to FIG. 6, the user can access a list of skills associated with one of these internal positions (in the example of FIG. 6, the “Lead Designer” position) to access a list 504 of the qualification attributes for the position that the user possesses. The user can also view and/or edit his level of proficiency for each of the qualification attributes, e.g., as previously entered by the user or by a supervisor or manager. In some cases, e.g., for the skill “Draw detailed or technical illustrations” 506, the user can access a list of tools associated with the skill, e.g., to view and/or edit tools at which he is proficient.

Referring now to FIGS. 5A and 5B, the user can view a list 508 of internal positions for which he is qualified. These positions are identified based on a match between the user's qualification attributes and the qualification attributes of the positions. Presenting the user with a list of positions for which he is qualified enables the user to explore internal opportunities, e.g., opportunities he may not have otherwise been aware of.

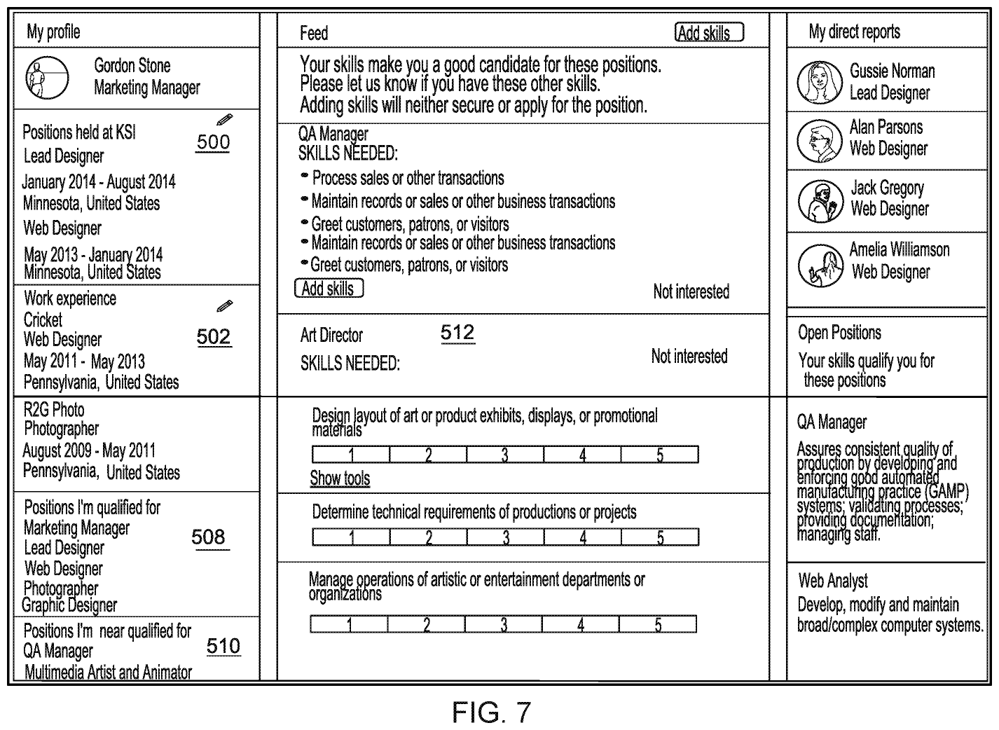

The user can also view a list 510 of internal positions for which he is nearly qualified for. A position for which the user is nearly qualified is a position for which the user possesses most, but not all, of the qualification attributes associated with the position. Referring also to FIG. 7, the user can access a list 512 of qualification attributes associated with one of these internal positions (in the example of FIG. 7, the “Art Director” position). The user can indicate if he possesses any of these qualification attributes. Referring again to FIGS. 5A and 5B, the user is also presented with a list 514 of training opportunities that can enable the user to acquire one or more qualification attributes, e.g., to help the user qualify for additional internal positions.

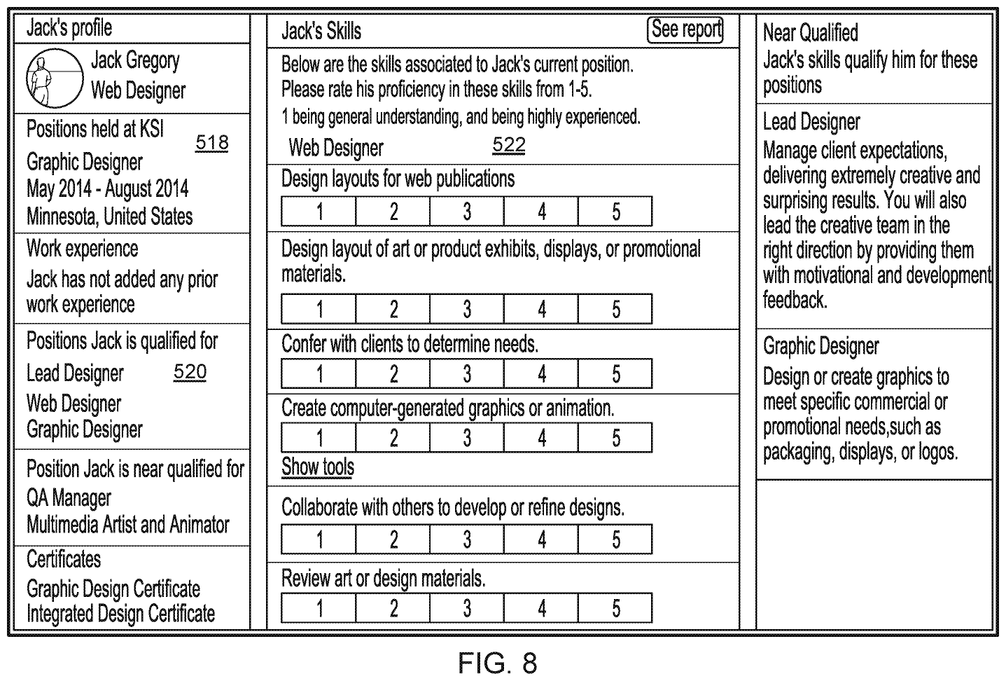

The user can also view a list 516 of employees the user supervises. Referring also to FIG. 8, for each employee, the user can access a list 518 of the employee's previously held internal and external positions and lists 520 of positions for which the employee is qualified and/or nearly qualified. The user can also be prompted 522 to rate the employee's proficiency in one or more skills associated with the employee's current position.

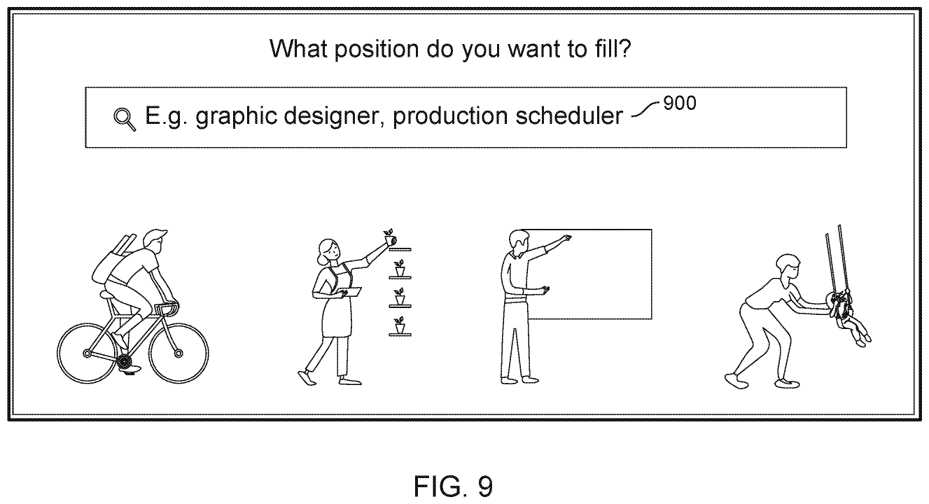

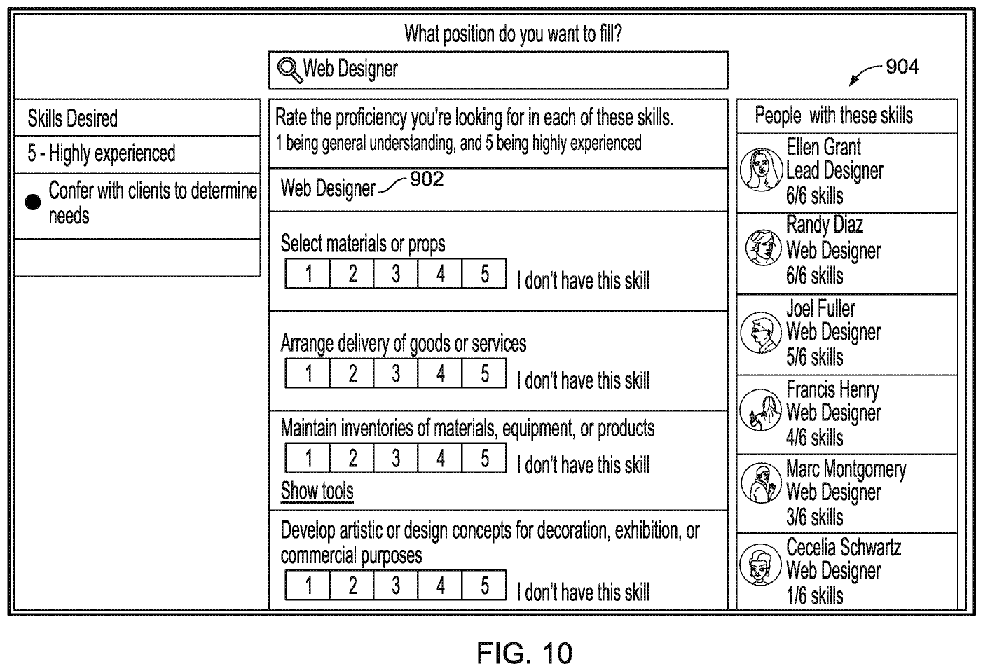

FIGS. 9-10 are screenshots of an internal resource management system implemented for internal staffing. A user, such as a project manager or a hiring manager, can create a position 900 and identify one or more desired qualifications 902 for the position. A list 904 of qualified candidates can be displayed to the user. The qualified candidates can be internal candidates and/or external candidates, e.g., depending on user preferences. The user can select one of the qualified candidates to view additional information about the candidate, such as the candidates current and/or previous positions, the candidate's qualifications, ratings, or other information. The use of the system for internal staffing enables a hiring manager or project manager to become aware of employees who are well suited to a project even if the manager may not necessarily have previously come into contact with these employees, thus facilitating the efficient use of employee qualifications within the company.

Other implementations are also within the scope of the following claims.

What is claimed is:

1. A method comprising:
receiving a request associated with a first attribute and a criterion, the request representative of an opportunity for employment, each first attribute representative of a qualification associated with the opportunity for employment, the criterion representative of a target affiliation;
querying a database to identify a record including a second attribute satisfying the first attribute associated with the request and including a third attribute satisfying the criterion associated with the request, the first attribute included in the record having been determined based on other information in the record; and
serving, to a computing device operated by a user associated with the identified record, a network resource providing the user with access to information about the request.

2. The method of claim 1, comprising updating a table to include a representation of the identified record.

3. The method of claim 1, comprising updating a data storage to include an identifier of the identified record.

4. The method of claim 1, comprising updating a data storage to include a reference to the identified record.

5. The method of claim 1, in which the criterion is representative of an employer.

6. The method of claim 1, in which the criterion is representative of a coalition of employers.

7. The method of claim 1, in which the criterion is representative of a first target affiliation and a second target affiliation, and in which querying the database includes:
querying the database to identify a record for which the third attribute matching the first target affiliation; and
if no record including a third attribute matching the first target affiliation is identified, querying the database to identify a record for which the third attribute matches the second target affiliation.

8. The method of claim 1, comprising:
querying the database to identify a second record associated with a second request representative of a second opportunity for employment, the second record including a third attribute satisfying the criterion, the second record not including an attribute satisfying the first attribute; and
serving, to the computing device, a network resource providing the user with access to information about the second request.

9. The method of claim 8, comprising:
identifying a training opportunity associated with an attribute satisfying the first attribute; and
serving, to the computing device, a network resource providing the user with access to information about the training opportunity.

10. A non-transitory computer readable medium storing instructions for causing a computing system to:
receive a request associated with a first attribute and a criterion, the request representative of an opportunity for employment, each first attribute representative of a qualification associated with the opportunity for employment, the criterion representative of a target affiliation;
query a database to identify a record including a second attribute satisfying the first attribute associated with the request and including a third attribute satisfying the criterion associated with the request, the first attribute included in the record having been determined based on other information in the record; and
serve, to a computing device operated by a user associated with the identified record, a network resource providing the user with access to information about the request.

11. The non-transitory computer readable medium of claim 10, the instructions causing the computing system to update a table to include a representation of the identified record.

12. The non-transitory computer readable medium of claim 10, the instructions causing the computing system to update a data storage to include an identifier of the identified record.

13. The non-transitory computer readable medium of claim 10, the instructions causing the computing system to update a data storage to include a reference to the identified record.

14. The non-transitory computer readable medium of claim 10, in which the criterion is representative of a first target affiliation and a second target affiliation, and in which querying the database includes:
querying the database to identify a record for which the third attribute matching the first target affiliation; and
if no record including a third attribute matching the first target affiliation is identified, querying the database to identify a record for which the third attribute matches the second target affiliation.

15. The non-transitory computer readable medium of claim 10, the instructions causing the computing system to:
query the database to identify a second record associated with a second request representative of a second opportunity for employment, the second record including a third attribute satisfying the criterion, the second record not including an attribute satisfying the first attribute; and
serve, to the computing device, a network resource providing the user with access to information about the second request.

16. The non-transitory computer readable medium of claim 15, the instructions causing the computing system to:
identify a training opportunity associated with an attribute satisfying the first attribute; and
serve, to the computing device, a network resource providing the user with access to information about the training opportunity.

17. A method comprising:
receiving, from a computing device associated with a first user, a request to access a second user record of a second user, the second user record including a group attribute and a qualification attribute;
determining that a first user record of the first user includes a role attribute sufficient to permit access to the second user record, and determining that the group attribute of the first user record satisfies a group attribute of the second user record;
based on the determining, serving, to the computing device associated with the first user, a network resource providing the first user with access to the second user record;
querying a database to identify an opportunity record including a qualification attribute, the qualification attribute of the second user record satisfying the qualification attribute of the opportunity record; and
serving, to the computing device associated with the first user, a network resource providing the first user with access to the opportunity record.

18. The method of claim 17, comprising querying the database to identify a second opportunity record including a qualification attribute, the qualification attribute of the second user record not satisfying the qualification attribute of the opportunity record.

19. The method of claim 18, comprising service, to the computing device associated with the first user, a network resource providing the first user with access to the second opportunity record.

20. The method of claim 18, comprising serving, to the computing device associated with the first user, a network resource providing the first user with access to information about a training opportunity associated with an attribute satisfying the qualification attribute of the second opportunity record.
